(19) United States
(12) Patent Application Publication
(10) Pub. No.: US 2012/0296106 A1
(43) Pub. Date: Nov. 22, 2012

(54) PROCESS FOR PREPARING ORGANOSILANES

(75) Inventors: Michael Stepp, Ueberackern (AT); Tobias Weiss, Burghausen (DE)

(73) Assignee: WACKER CHEMIE AG, Muenchen (DE)

(21) Appl. No.: 13/497,673

(22) PCT Filed: Oct. 19, 2010
(86) PCT No.: PCT/EP10/65668

§ 371 Date: Mar. 22, 2012

(30) Foreign Application Priority Data
Oct. 28, 2009 (DE) 10 2009 046 121.3

(51) Int. Cl. C07F 7/16

(52) U.S. Cl. 556/481

(57) ABSTRACT

The invention relates to a process for preparing diorganyldihalosilanes of the general formula (1) R₂SiX₂ (1), in which dihalodihydrosilanes of the general formula (2) X₂SiH₂ (2), in a mixture with silanes of the general formula (3) R′₃SiH (3), are reacted with halogenated hydrocarbons of the general formula (4) R-X (4), in the presence of a free-radical initiator, which is selected from alkanes, diazenes and organodisilanes, where R is a monovalent C₁-C₁₈ hydrocarbon radical, R′ is a monovalent C₁-C₁₈ hydrocarbon radical, hydrogen or halogen, and X is halogen.

The invention relates to a process for preparing organosilanes from hydrosilanes and halohydrocarbons in the presence of a free-radical initiator.

With regard to the prior art, reference is made to the introduction in the laid-open specification DE 10349286 A1. Said laid-open specification describes among other things the preparation of phenylchlorosilanes starting in each case from the corresponding hydrogenchlorosilane with chlorobenzene in the presence of a free-radical initiator.

For the preparation of diphenyldichlorosilane, for example, it would be necessary in that case to start from dichlorosilane, which on account of its high ignition capacity (ignition temperature 55° C.) poses a large challenge to plant safety. On the industrial scale, therefore, operating disruptions with release of substance under conditions typical of the process—that is, with surface temperatures generally well above the ignition temperature of dichlorosilane—may have catastrophic consequences.

It is an object of the invention to provide a process for preparing diorganyldihalosilanes with high specific yield that forms few unwanted byproducts and which is safe to operate.

The invention provides a process for preparing diorganyldihalosilanes of the general formula (1)

R₂SiX₂ (1),

wherein dihalodihydrosilanes of the general formula (2)

X₂SiH₂ (2),

in a mixture with silanes of the general formula (3)

R′₃SiH (3),

are reacted with halohydrocarbons of the general formula (4)

R-X (4),

in the presence of a free-radical initiator selected from alkanes, diazenes, and organodisilanes, where
R is a monovalent C₁-C₁₈ hydrocarbon radical,
R′ is a monovalent C₁-C₁₈ hydrocarbon radical, hydrogen or halogen, and
X is halogen.

Blends of dihalodihydrosilanes of the general formula (2), more particularly dichlorosilane, with silanes of the general formula (3), more particularly trichlorosilane, exhibit increasing ignition temperatures in line with the increasing proportion of silanes of the general formula (3). For example, a mixture of 10% by weight of dichlorosilane and 90% by weight of trichlorosilane already possesses an ignition temperature of 130° C. Mixtures with 5%-50% by weight of dichlorosilane and, correspondingly, 95%-50% by weight of trichlorosilane are obtained, for example, as distillates in large quantities in the production of chlorosilane for the manufacture of ultrapure silicon for the semiconductor or photovoltaic industry.

If these chlorosilane mixtures are used, then the process of the invention, through reaction with chlorobenzene, produces mixtures which contain not only diphenyldichlorosilane but also phenyltrichlorosilane. Since both products are needed, it is appropriate to operate production plants whose purpose is to generate phenyltrichlorosilane with a mixture of di- and trichlorosilane and hence to prepare both derivatives in one step. Any purification that may be necessary can take place subsequent to the preparation, by distillation, for example. As a result of this regime, time-consuming and costly run-in and run-down phases, and also capital investments in complete new plants, can be avoided.

It has been found, surprisingly, that when using mixtures of silane of the general formula (2) with silanes of the general formula (3), in comparison to the use of pure silane of the general formula (2), with a given SiH/halohydrocarbons of the general formula (4) ratio, the resulting yields of diorganyldihalosilanes of the general formula (1) are higher, based on the amount of silane of the general formula (2) reacted.

At the same time, the formation of unwanted byproducts, as for example of the unwanted phenyldichlorosilane in the preparation of diphenyldichlorosilane from dichlorosilane, and also the formation of benzene and chlorinated biphenyls, is suppressed, thereby simplifying the purification process.

It is preferred to use free-radical initiators which decompose by half at 500° C. within at least 5 seconds, more particularly at least 3 seconds, and preferably not more than 30 seconds, more particularly not more than 15 seconds.

As free-radical initiators it is preferred to use alkanes of the general formula (5)

R¹R²R³C-CR⁴R⁵R⁶ (5)

where

R¹ to R⁶ may be alkyl radical, or

R¹ and R⁴ may be phenyl radical and R², R³, R⁵ and R⁶ may be hydrogen or alkyl radical, or

R¹ and R⁴ may be phenyl radical and R² and R⁵ may be phenyl radical or alkyl radical, and R³ and R⁶ may be trialkoxysiloxy radical, or

R¹, R², R⁴ and R⁵ may be phenyl radical and R³ and R⁶ may be hydrogen, alkyl or trialkylsiloxy radical,

or diazenes of the general formula (6)

R⁷—N═N—R⁸ (6),

where R⁷ and R⁸ may be C₁-C₁₈ hydrocarbon radicals,

or organodisilanes of the general formula (7)

R⁹₃Si—SiR₃¹⁰ (7),

where R⁹ and R¹⁰ may be halogen or C₁-C₁₈ hydrocarbon radicals.

Preferred alkyl radicals here are C₁-C₆ alkyl radicals, more particularly the methyl, ethyl or n-propyl radical, and a preferred trialkylsiloxy radical is the trimethylsiloxy radical. R⁷ and R⁸ are preferably alkyl, aryl or aralkyl radicals. R⁹ and R¹⁰ are preferably C₁-C₆ alkyl radicals, more particularly the methyl or ethyl radical, or chlorine.

Particularly good results are obtained with 1,2-diphenylethane, 2,3-diphenyl-2,3-dimethylbutane, 1,1,2,2-tetraphenylethane, 3,4-dimethyl-3,4-diphenylhexane, dicyclohexyldiazene and di-tert-butyldiazene.

X and R′ in the definition of halogen are preferably fluorine, chlorine and bromine, more particularly chlorine. With particular preference the silane of the general formula (2) is dichlorosilane.

The radicals R′ are preferably phenyl radicals or C₁-C₆ alkyl radicals, more particularly methyl or ethyl radicals, or chlorine. Preferred compounds of the general formula (3) are trichlorosilane, methyldichlorosilane, dimethylchlorosilane and ethyldichlorosilane.

With particular preference the silane of the general formula (3) is trichlorosilane. It is, however, also possible to use mixtures of different compounds of the general formula (3) in the process of the invention.

The radicals R preferably have C═C double bonds. The radicals R are preferably alkenyl radicals preferably having 2 to 6 carbon atoms, such as vinyl, allyl, methallyl, 1-propenyl, 5-hexenyl, ethynyl, butadienyl, hexadienyl, cyclopentenyl, cyclopentadienyl, cyclohexenyl, preferably vinyl and allyl radicals; aryl radicals, such as phenyl radicals; alkaryl radicals, aralkyl, alkenylaryl or arylalkenyl radicals; phenylalkenyl radicals.

With particular preference the halohydrocarbon of the general formula (4) is halobenzene, more particularly chlorobenzene.

The halohydrocarbon of the general formula (4) is preferably reacted with the mixture of the hydrosilanes of the general formulae (2) and (3) in a molar ratio of halogen:Si-bonded hydrogen of not more than 4:1, more particularly not more than 1.5:1.0 and at least 1:4, more preferably not more than 3:1. The amount of alkane or diazene used as free-radical initiator in this case is preferably at least 0.005% by weight, more particularly at least 0.01% by weight, and not more than 3% by weight, more particularly not more than 0.5% by weight, based on mixture of halohydrocarbon of the general formula (4) and hydrosilanes of the general formulae (2) and (3) used. In the case of the use of organodisilanes, more particularly disilanes (e.g., the high-boiling fraction from the distillation residue of the Rochow synthesis of dichlorodimethylsilane) as free-radical initiator, it is preferred to use at least 1% by weight, more particularly at least 2% by weight, and not more than 15% by weight, more particularly not more than 10% by weight, based on mixture of halohydrocarbon of the general formula (4) and hydrosilanes of the general formulae (2) and (3) used.

More particularly, diphenyldichlorosilane is prepared from dichlorosilane by reaction with chlorobenzene in accordance with the process of the invention.

In the case of the preparation of diphenyldichlorosilane in a mixture with phenyltrichlorosilane by reaction of chlorobenzene with a mixture of dichlorosilane and trichlorosilane, in one preferred embodiment of the process of the invention, a product stream from the distillation of chlorosilane for the production of ultrapure silicon is used. This product stream may, as well as dichlorosilane and trichlorosilane, in fractions of up to preferably not more than 50%, comprise other chlorosilanes from the chlorosilane synthesis starting from metallurgical silicon and hydrogen chloride, preferably tetrachlorosilane and methyldichlorosilane.

Present in addition, to a minor extent, there may be metal chlorides such as aluminum chloride, titanium chloride, and iron chloride. The mass ratio of dihalodihydrosilane of the general formula (2):silane of the general formula (3) is preferably at least 1:99, more particularly at least 5:95, and preferably not more than 90:10, more preferably not more than 50:50, more particularly not more than 30:70. The mixing ratio desired in each case may be realized optionally by blending of different silane grades/silane mixtures.

The process of the invention is carried out preferably at temperatures of at least 300° C., more particularly at least 400° C., and preferably not more than 800° C., more preferably not more than 600° C. It is carried out preferably under the pressure of the surrounding atmosphere or under a slight overpressure, which comes about as a result of scrubber systems and ventilation systems, in other words at approximately 1000 to 1200 hPa, optionally also at higher pressures, and is preferably subdivided into the following steps:
1. mixing of the reactants
2. heating of the reaction mixture
3. cooling/condensation of the reaction mixture
4. optional purification of the individual components by distillation of crystallization

The process of the invention is carried out preferably in a reactor made of steel, with the mixture of hydrosilanes of the general formulae (2) and (3) and halohydrocarbons of the general formula (4), preferably mixture of chlorobenzene, and also dichlorosilane with trichlorosilane, and free-radical initiator, being fed in preferably in vapor form. For this purpose, preferably, the liquid components—which either are premixed in the desired ratio in a mixing assembly (static mixer or active mixer) or are obtained directly as a mixture in a process—are passed through an evaporator and the vapors are subsequently passed through a heat exchanger, so as to enter the reactor zone at approximately reaction temperature. This arrangement further ensures that even low-volatility initiators are transported into the reactor. Free-radical initiators which are solid at room temperature are used, in one preferred embodiment, in the form of a solution in chlorobenzene. The residence time of the reaction mixture in the reactor is preferably at least 2 seconds, more particularly at least 5 seconds, and not more than 80 seconds, more particularly not more than 50 seconds.

The individual constituents of the reaction mixture are purified preferably, after removal of the volatile constituents, more particularly of the hydrogen halide formed in the reaction, by distillation or crystallization, more preferably by distillation under reduced pressure. The hydrogen halide formed is preferably bound in a scrubber system and optionally neutralized or, with particular preference, passed to a valorization process. The process of the invention is preferably carried out continuously. In this context it may be advantageous, for the purpose, for example, of completing the conversion, to feed substreams from the work-up of the reaction mixture back into the reactor. In the reaction of dichlorosilane/trichlorosilane mixtures with chlorobenzene by the process of the invention, for example, incomplete conversion produces phenyldichlorosilane, which following distillative isolation can be fed back into the reactor in a mixture with the reactant mixture.

The materials in the components must be resistant to the media under the prevailing pressures and temperatures. Besides steel, preferred suitability is possessed by quartz, graphite, silicon, silicon carbide, and silicon nitride.

On account of the sensitivity of the halosilanes to hydrolysis it is necessary very largely to exclude moisture from the reactants. The water concentration in the feedstock compounds preferably does not exceed 0.5% by weight, in order to prevent formation of silicic acid and oligomeric or polymeric siloxanes. Similarly, oxygen and oxygen-containing compounds are tolerable preferably only in the trace range (<0.2%), on account of possible unwanted side-reactions.

The flow rates (kg/h) can be adjustable variably within limits according to reactor design (volume, pressure loss) and can be optimized from economic standpoints. For example, it may be sensible to reduce the throughput and thus to increase the residence time if this allows a better space-time yield to be achieved. Conversely, unwanted reactions may result from this, possibly leading to the deposition of solids in the reactor system.

In the inventive and comparative examples below, unless indicated otherwise, all amounts figures and percentage figures are based on the weight, and all reactions are carried out under an ambient pressure of 0.10 MPa (absolute) and at an ambient temperature of 20° C.

### EXAMPLES

Apparatus:

In a quartz glass apparatus consisting of evaporator flask with an inlet valve for argon or nitrogen, top-mounted tube with heating jacket as reaction zone, bridge with cooling jacket, sampling flask for the condensable reaction products, and waste-gas pipe fitted with cooling jacket, it is possible to carry out reactions of dichlorosilane and also of mixtures of trichlorosilane and dichlorosilane with chlorobenzene under different conditions. The heating bath around the evaporator flask, the bath being operated with silicone fluid, is conditioned at 170° C., the cooling (likewise with silicone fluid) at −35° C. Via the waste-gas system with the integrated scrubbers, an overpressure of approximately 60 mbar relative to atmospheric pressure is built up in the apparatus. The temperature in the reaction zone is determined with the aid of a thermocouple which protrudes into the hot reaction zone. The sample is taken from the sampling flask via the bottom valve, by means of an evacuated sample vessel, and is analyzed by gas chromatography.

Procedure:

Following inertization with argon, the quartz tube is brought to the desired temperature by electrical heating. From a reservoir container, the halosilane/halohydrocarbon/initiator mixture (chlorosilanes are products of Wacker Chemie AG) is metered into the evaporator flask. Liquid metering takes place at a rate such that the quantity metered undergoes complete evaporation immediately as far as possible. In addition, for inertization, 5 l/h of argon are passed in. The condensate collects after a few seconds in the sampling flask. As soon as a representative amount has accumulated, the metering is interrupted and a sample is taken from the liquid condensate, under argon, and injected into a gas chromatograph.

### Inventive Example 1

A mixture of 354 g of chlorobenzene, 75 g of trichlorosilane, 25 g of dichlorosilane (SiH:chlorobenzene molar ratio=1:3), and 0.5 g of 1,2-diphenylethane was metered at a rate of 80 g/h into the evaporator flask. The temperature in the reaction zone was 600° C., the residence time 10 seconds. After half an hour, the metering was ended. Approximately 40 g of yellowish condensate had collected in the reservoir flask. According to analysis by gas chromatography, the condensate, in addition to unreacted dichlorosilane (0.28%), trichlorosilane (4.11%), and chlorobenzene (68.9%), contained

12.33% of phenyltrichlorosilane

1.83% of diphenyldichlorosilane

1.97% of phenyldichlorosilane

3.37% of tetrachlorosilane

4.95% of benzene, and 0.372% of mixture of the mono-chlorobiphenyl isomers.

From this, a dichlorosilane conversion of 95% and a corresponding yield of diphenyldichlorosilane of 15% of theory are calculated.

### Comparative Example 1

A mixture of 468 g of chlorobenzene, 70 g of dichlorosilane (SiH:chlorobenzene molar ratio=1:3), and 0.5 g of 1,2-diphenylethane was metered at a rate of 80 g/h into the evaporator flask. The temperature in the reaction zone was 600° C., the residence time 10 seconds. After half an hour, the metering was ended. 38 g of yellowish condensate had collected in the reservoir flask. According to analysis by gas chromatography, the condensate, in addition to unreacted dichlorosilane (1.17%), trichlorosilane (1.69%), and chlorobenzene (74%), contained

6.17% of phenyltrichlorosilane

3.61% of diphenyldichlorosilane

4.8% of phenyldichlorosilane

5.64% of benzene, and 0.445% of mixture of the monochlorobiphenyl isomers.

From this, a dichlorosilane conversion of 91% and a corresponding yield of diphenyldichlorosilane of 11.5% of theory are calculated.

### Inventive Example 2

A mixture of 354 g of chlorobenzene, 75 g of trichlorosilane, 25 g of dichlorosilane (SiH:chlorobenzene molar ratio=1:3), and 0.5 g of 1,2-diphenylethane was metered at a rate of 80 g/h into the evaporator flask. The temperature in the reaction zone was 650° C., the residence time 10 seconds. After half an hour, the metering was ended. 37 g of yellowish condensate had collected in the reservoir flask. According to analysis by gas chromatography, the condensate, in addition to unreacted dichlorosilane (0.03%), trichlorosilane (1.22%), and chlorobenzene (60%), contained

17.9% of phenyltrichlorosilane

2.6% of diphenyldichlorosilane

0.66% of phenyldichlorosilane

5.1% of tetrachlorosilane

7.53% of benzene, and 0.634% of mixture of the monochlorobiphenyl isomers.

From this, a dichlorosilane conversion of 99% and a corresponding yield of diphenyldichlorosilane of 17.5% of theory are calculated.

### Comparative Example 2

A mixture of 468 g of chlorobenzene, 70 g of dichlorosilane (SiH:chlorobenzene molar ratio=1:3), and 0.5 g of 1,2-diphenylethane was metered at a rate of 80 g/h into the evaporator flask. The temperature in the reaction zone was 650° C., the residence time 10 seconds. After half an hour, the metering was ended. 33 g of yellowish condensate had collected in the reservoir flask. According to analysis by gas chromatography, the condensate, in addition to unreacted dichlorosilane (0.19%), trichlorosilane (0.80%), and chlorobenzene (66%), contained

10.7% of phenyltrichlorosilane

5.11% of diphenyldichlorosilane

1.82% of phenyldichlorosilane

8.87% of benzene, and 0.738% of mixture of the monochlorobiphenyl isomers.

From this, a dichlorosilane conversion of 99% and a corresponding yield of diphenyldichlorosilane of 13% of theory are calculated.

### Inventive Example 3

A mixture of 354 g of chlorobenzene, 75 g of trichlorosilane, 25 g of dichlorosilane (SiH:chlorobenzene molar ratio=1:3), and 0.5 g of 1,2-diphenylethane was metered at a rate of 100 g/h into the evaporator flask.

The temperature in the reaction zone was 600° C., the residence time 8 seconds. After half an hour, the metering was ended. 48 g of yellowish condensate had collected in the reservoir flask. According to analysis by gas chromatography, the condensate, in addition to unreacted dichlorosilane (0.45%), trichlorosilane (5.29%), and chlorobenzene (68.4%), contained

11.82% of phenyltrichlorosilane

1.67% of diphenyldichlorosilane

2.28% of phenyldichlorosilane

3.42% of tetrachlorosilane

4.82% of benzene, and 0.334% of mixture of the monochlorobiphenyl isomers.

From this, a dichlorosilane conversion of 92% and a corresponding yield of diphenyldichlorosilane of 13% of theory are calculated.

### Comparative Example 3

A mixture of 468 g of chlorobenzene, 70 g of dichlorosilane (SiH:chlorobenzene molar ratio=1:3), and 0.5 g of 1,2-diphenylethane was metered at a rate of 100 g/h into the evaporator flask. The temperature in the reaction zone was 600° C., the residence time 8 seconds. After half an hour, the metering was ended. 48 g of yellowish condensate had collected in the reservoir flask. According to analysis by gas chromatography, the condensate, in addition to unreacted dichlorosilane (1.15%), trichlorosilane (1.83%), and chlorobenzene (73.54%), contained

6.21% of phenyltrichlorosilane

3.56% of diphenyldichlorosilane

4.79% of phenyldichlorosilane

5.79% of benzene, and 0.459% of mixture of the monochlorobiphenyl isomers.

From this, a dichlorosilane conversion of 91% and a corresponding yield of diphenyldichlorosilane of 10% of theory are calculated.

1. A process for preparing diorganyldihalosilanes of the general formula (1)
R₂SiX₂ (1),
wherein a dihalodihydrosilane of the general formula (2)
X₂SiH₂ (2),
in a mixture with a silane of the general formula (3)
R′₃SiH (3),
are reacted with a halohydrocarbon of the general formula (4)
R-X (4),
in a presence of a free-radical initiator selected from alkanes, diazenes, and organodisilanes, where
R is a monovalent C₁-C₁₈ hydrocarbon radical,
R′ is a monovalent C₁-C₁₈ hydrocarbon radical, hydrogen or halogen, and
X is halogen.

2. The process as claimed in claim 1, wherein the free-radical initiator decomposes by half at 500° C. within at least 5 to 30 seconds.

3. The process as claimed in claim 1, wherein the free-radical initiator is an alkane of the general formula (5)
R¹R²R³C—CR⁴R⁵R⁶ (5),
where
R¹ to R⁶ may be alkyl radical, or
R¹ and R⁴ may be phenyl radical and R², R³, R⁵ and R⁶ may be hydrogen or alkyl radical, or
R¹ and R⁴ may be phenyl radical and R² and R⁵ may be phenyl radical or alkyl radical, and R³ and R⁶ may be trialkoxysiloxy radical, or
R1¹, R², R⁴ and R⁵ may be phenyl radical and R³ and R⁶ may be hydrogen, alkyl or trialkylsiloxy radical,
or diazenes of the general formula (6)
R⁷—N═N—R⁸ (6),
where R⁷ and R⁸ may be C₁-C₁₈ hydrocarbon radicals,
or organodisilanes of the general formula (7)
R⁹₃Si—SiR₃¹⁰ (7)
where R⁹ and R¹⁰ may be halogen or C₁-C₁₈ hydrocarbon radicals.

4. The process as claimed in claim 1, wherein the halohydrocarbon of the general formula (4) is chlorobenzene.

5. The process as claimed in claim 1, wherein the halohydrocarbon of the general formula (4) is reacted with the mixture of hydrosilanes of the general formulae (2) and (3) in a molar ratio of halogen:Si-bonded hydrogen of 4:1 to 1:4.

6. The process as claimed in claim 1, wherein diphenyldichlorosilane is prepared by reacting dichlorosilane with chlorobenzene.

7. The process as claimed in claim 1, wherein a mass ratio of dihalodihydrosilane of the general formula (2):silane of the general formula (3) is 1:99 to 50:50.

8. The process as claimed in claim 1, which is carried out at temperatures of 300° C. to 800° C.

9. The process as claimed in claim 1, wherein 0.005% by weight to 3% by weight, based on a mixture of the halohydrocarbon of the general formula (4) and hydrosilanes of the general formulae (2) and (3) employed, of alkane or diazene is used as the free-radical initiator.

10. The process as claimed in claim 2, wherein the free-radical initiator is an alkane of the general formula (5)
R¹R²R³C—CR⁴R⁵R⁶ (5),
where
R¹ to R⁶ may be alkyl radical, or
R¹ and R⁴ may be phenyl radical and R², R³, R⁵ and R⁶ may be hydrogen or alkyl radical, or
R¹ and R⁴ may be phenyl radical and R² and R⁵ may be phenyl radical or alkyl radical, and R³ and R⁶ may be trialkoxysiloxy radical, or
R¹, R², R⁴ and R⁵ may be phenyl radical and R³ and R⁶ may be hydrogen, alkyl or trialkylsiloxy radical, or diazenes of the general formula (6)
R⁷—N═N—R⁸ (6),
where R⁷ and R⁸ may be C₁-C₁₈ hydrocarbon radicals,
or organodisilanes of the general formula (7)
R⁹₃Si—SiR₃¹⁰ (7),
where R⁹ and R¹⁰ may be halogen or C₁-C₁₈ hydrocarbon radicals.

11. The process as claimed in claim 10, wherein the halohydrocarbon of the general formula (4) is chlorobenzene.

12. The process as claimed in claim 11, wherein the halohydrocarbon of the general formula (4) is reacted with the mixture of hydrosilanes of the general formulae (2) and (3) in a molar ratio of halogen:Si-bonded hydrogen of 4:1 to 1:4.

13. The process as claimed in claim 12, wherein diphenyldichlorosilane is prepared by reacting dichlorosilane with chlorobenzene.

14. The process as claimed in claim 13, wherein a mass ratio of dihalodihydrosilane of the general formula (2):silane of the general formula (3) is 1:99 to 50:50.

15. The process as claimed in claim 14, which is carried out at temperatures of 300° C. to 800° C.

16. The process as claimed in claim 15, wherein 0.005% by weight to 3% by weight, based on a mixture of the halohydrocarbon of the general formula (4) and hydrosilanes of the general formulae (2) and (3) employed, of alkane or diazene is used as the free-radical initiator.
